(19) United States
(12) Patent Application Publication
(10) Pub. No.: US 2017/0031926 A1
(43) Pub. Date: Feb. 2, 2017

(54) Development of a Motility Scoring Methodology to Facilitate Urbanomic Mobility

(71) Applicant: Cubic Corporation, San Diego, CA (US)

(72) Inventors: John Katircioglu, Arlington, VA (US); Ronald Wade Rosado, Fairfield, CA (US); Daniel H. Collins, Alexandria, VA (US)

(21) Appl. No.: 15/221,168

(22) Filed: Jul. 27, 2016

Related U.S. Application Data
(60) Provisional application No. 62/198,534, filed on Jul. 29, 2015.

(51) Int. Cl. G06F 17/30; G01C 21/34; G01C 21/32

(52) U.S. Cl. CPC G06F 17/30061; G01C 21/32; G01C 21/3492; G06F 17/30241; H04L 67/22

(57) ABSTRACT

Embodiments of the invention combine two primary factors to provide a score that is analyzed to produce an optimal coordinate map. These two primary factors are synchronized to drive user behavior. According to some embodiments the concept of attractiveness of a coordinate point is affected by the navigability to that coordinate point. The second primary factor is the measure of the merit of the activity at a coordinate point. Accordingly, the metric is determined by synchronizing the navigability to a coordinate point with the merit of the activity at that coordinate point to arrive at an optimal coordinate map containing coordinate points that match given constraints.

### CROSS-REFERENCES TO RELATED APPLICATIONS

This application is a nonprovisional of and claims the benefit of priority to U.S. Provisional Patent Application No. 62/198,534, filed Jul. 29, 2015, entitled “Development of a Motility Scoring Methodology to Facilitate Urbanomic Mobility,” the entire content of which is herein incorporated in its entirety.

### BACKGROUND OF THE INVENTION

Previous use cases for locating optimal coordinate points used incomplete data such as spending and traffic to identify desirable coordinate points. Those use cases failed to take into account dynamic navigational data or merit of activity at the coordinate points.

### BRIEF SUMMARY OF THE INVENTION

One embodiment of the current invention is a method for generating a coordinate map by synchronizing navigability with merit of activity at coordinate points. The method comprises receiving a query, from a user device for the coordinate map, over a network, the query including an origination point, and one or more constraints, the one or more constraints comprising: an activity, a first time, one or more changes; and one or more types. The method also comprises fetching first data, from one or more servers, over the network, wherein the first data includes usage, schedules, and/or routes, and fetching second data from the one or more servers, over the network, wherein the second data includes data for the activity and/or data for the one or more types. The method further comprises: manipulating the first data using a transit analyzer to produce a first result; manipulating the first data and the second data using a use analyzer to produce a second result; and manipulating the first data and the second data using a geo analyzer to produce a third result. And the method yet still comprises transforming the first result, the second result, and the third result into the coordinate map comprising at least a second coordinate point, wherein the second coordinate point complies with the one or more constraints. Finally the method comprises embedding the coordinate map into a notification and sending, over the network, the notification to the user device. The method can also include a geographic area constraint or a second time for a first type constraint. The activities in the method can further comprise dinging at an eating establishment, shopping at a retail establishment, recreational activities, or going to work.

Yet another embodiment of the invention is a system for generating a coordinate map by synchronizing navigability with merit of activity at coordinate points. The system comprises a network, a mobility processor, one or more servers, a fetch system, a transit analyzer, a use analyzer, a geo analyzer, and a GUI generator. The mobility processor is configured to: receive a query from a user device, over the network, for the coordinate map, including an origination point, and one or more constraints, the one or more constraints comprising: an activity, a first time, one or more changes, and one or more types. The mobility processor further embeds the coordination map in a notification; and sends the notification to the user device, over the network. The fetch system is configured to retrieve, over the network: first data from the one or more servers, wherein the first data includes usage, schedules, and/or routes; and second data from the one or more servers, wherein the second data includes data for the activity and/or data for the one or more types. The transit analyzer is configured to manipulate the first data to produce a first result. The use analyzer is configured to manipulate the first data and the second data to produce a second result. And the geo analyzer is configured to manipulate the first data and the second data to produce a third result. Finally, the GUI generator is configured to transform the first result and second result and the third result into the coordinate map comprising at least a second coordinate point, wherein the second coordinate point complies with the one or more constraints. The system can also include additional constraints such as geographic area and a second time for one type. The system can also include the activities of dining at a restaurant, shopping at a retail establishment, a recreational activity, or going to work.

Yet a third embodiment is a non-transitory computer readable medium, for generating a coordinate map by synchronizing navigability with merit of activity at coordinate points, having instruction sets stored thereon that, when executed by computer, cause the computer to perform multiple functions. One of those functions is receiving a query from a user device, over a network, for the coordinate map, including an origination point, and one or more constraints. The constraints include: an activity, a first time, one or more changes, and one or more types. Another system function is fetching first data, over the network, from one or more servers, wherein the first data includes usage, schedules, and/or routes, and fetching second data, over the network, from the one or more servers, wherein the second data includes data for the activity and/or data for the one or more types. Another function performed by the system is to: manipulate the first data to produce a first result; manipulate the first data and the second data to produce a second result; and manipulate the first data and the second data to produce a third result. Further—another system function transforms the first result and second result and the third result into the coordinate map comprising at least a second coordinate point, wherein the second coordinate point complies with the one or more constraints. And, a final function is to embed the coordination map in a notification; and send the notification to the user device, over the network. Further system constraints are time of day and geographic area. System activities include dining at restaurant, shopping at retail establishment, and recreational activities.

### BRIEF DESCRIPTION OF THE DRAWINGS

The present disclosure is described in conjunction with the appended figures:

FIG. 1 depicts a block diagram of the overview of a coordinate mapping system;

FIG. 2 depicts a block diagram of a mobility system;

FIG. 3A depicts a block diagram of system-wide data resource;

FIG. 3B depicts a block diagram of transit data resource;

FIG. 4 depicts a coordinate map with possible coordinate points navigationally assessable in a given time period;

FIG. 5 depicts a coordinate map with possible coordinate points navigationally assessable in a given time period with the option of a directional change;

FIG. 6 depicts a coordinate map with possible coordinate points navigationally assessable in a given time period.

FIG. 7 depicts a coordinate map with possible coordinate points navigationally assessable constrained by time and one navigational system change;

FIG. 8 depicts a coordinate map with possible coordinate points navigationally assessable constrained by time and two navigational system changes;

FIG. 9 depicts a coordinate map with possible coordinate points navigationally assessable constrained by time, two navigational system changes, and two navigation types;

FIG. 10 depicts a coordinate map with possible coordinate points navigationally assessable constrained by time, two navigational system changes, and two navigation types overlaid on a geographic map associated with the navigational systems;

FIG. 11 depicts a coordinate map with possible coordinate points navigationally assessable constrained by time, two navigational system changes, and three navigation types overlaid on a geographic map associated with the navigational systems during a weekday;

FIG. 12 depicts a coordinate map with possible coordinate points navigationally assessable constrained by time, two navigational system changes, and three navigation types overlaid on a geographic map associated with the navigational systems during a weekend day;

FIG. 13 depicts a coordinate map with possible coordinate points navigationally assessable constrained by time, two navigational system changes, and two navigation types overlaid on a geographic map associated with the navigational systems during an evening;

FIG. 14 shows coordinate maps from FIGS. 11, 12 and 13 overlaid on one another to depict the dynamic nature of a coordinate map;

FIG. 15 depicts a table showing bearing and distance between coordinate points;

FIG. 16 depicts the geometrical algorithm for computing the bearing and distance from FIG. 15;

FIG. 17 Table 2 that enumerates examples of some of the various use cases for coordinate mapping; and

FIG. 18 depicts a geo-coordinate heat map.

### DETAILED DESCRIPTION OF THE INVENTION

Embodiments of the invention combine two primary factors to provide a score that is analyzed to produce an optimal coordinate map. These two primary factors are synchronized to drive user behavior. According to some embodiments one primary factor is how the coordinate point is affected by the navigability to that coordinate point. The second primary factor is a measure of the merit of the activity at a coordinate point. Accordingly, the score is determined by synchronizing the navigability to a coordinate point with the merit of the activity at that coordinate point to arrive at an optimal coordinate map containing coordinate points that meet the supplied constraints. A coordinate point is an address, bus stop, train stop, metro stop, or any other geographical identifier. A coordinate map is essentially a user's travel horizon.

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

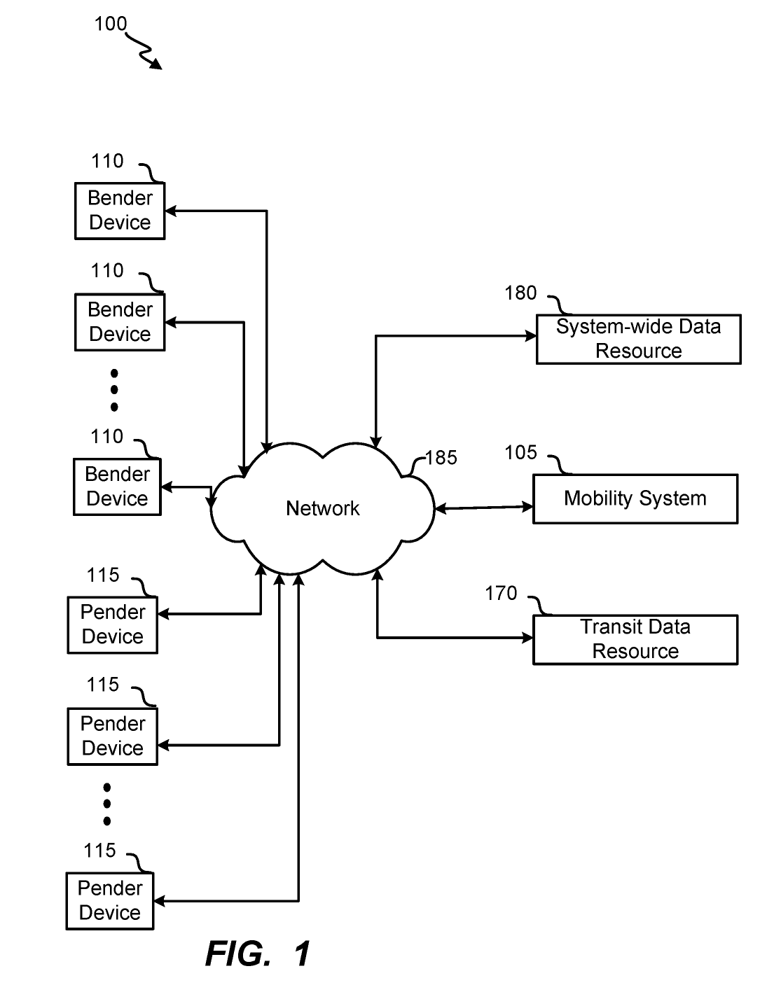

FIG. 1 depicts a block diagram of the overview of a coordinate mapping system 100. The heart of the coordinate mapping system 100, the mobility system 105 described in further detail below, synchronizes the navigability to and the merit at coordinate points to form a coordinate map based on constraints supplied by users. There are at least two types of users for the mobility system. There are personal users referred to as penders in this description that use pender devices 115 to communicate with the mobility system 105 over the network 185. Pender devices 115 can be any device that allows the pender to interact with the mobility system such as a terminal, desktop computer, laptop computer, tablet computer, mini-tablet computer, smart-phone, or any other device with a display such as an LED or any other kind of screen and input mechanism such as a keyboard, touch screen keyboard, or voice command input in communication with mobility system 105. As depicted—any number of pender's 115 can simultaneously use the coordinate mapping system 100 over the network 185. There are also business users referred to as benders in this description that use bender devices 110 to communicate with the mobility system 105 over network 185. Bender devices 110 can be any device that allows the bender to interact with the mobility system such as a terminal, desktop computer, laptop computer, tablet computer, mini-tablet computer, smart-phone, or any other device with a display such as an LED or any other type of screen and input mechanism such as a keyboard, touch screen keyboard, or voice command input in communication with mobility system 105. As depicted, any number of benders can simultaneously use the coordinate mapping system 100 over network 185.

The coordinate mapping system 100 uses the data provided by transit data resource 170 in order to accurately create coordinate maps. The coordinate mapping systems 100 also uses the data provided by system-wide data resource 180 to create coordinate maps. The mobility system 105, bender devices 110, pender devices 115, transit data resource 170 and system-wide data resource 180 all communicate over the network 185. Network 185 is a system of computers and peripherals that are linked together and can consist of as few as two computing devices connected or millions of computers over a large geographical area with or without wires—such as the internet or the cellular telephone network.

GUI generator 245 generates the interface that the mobility system 105 sends to the pender device 115 or the bender device 110. The GUI generator 245 is software that works at the interface between a device and the device user that incorporates graphical element like icons and menus to allow the user to interact with the device. GUI generator 245 generate an interface for each device including smart phones, tablet computers, desk top computers, and terminals.

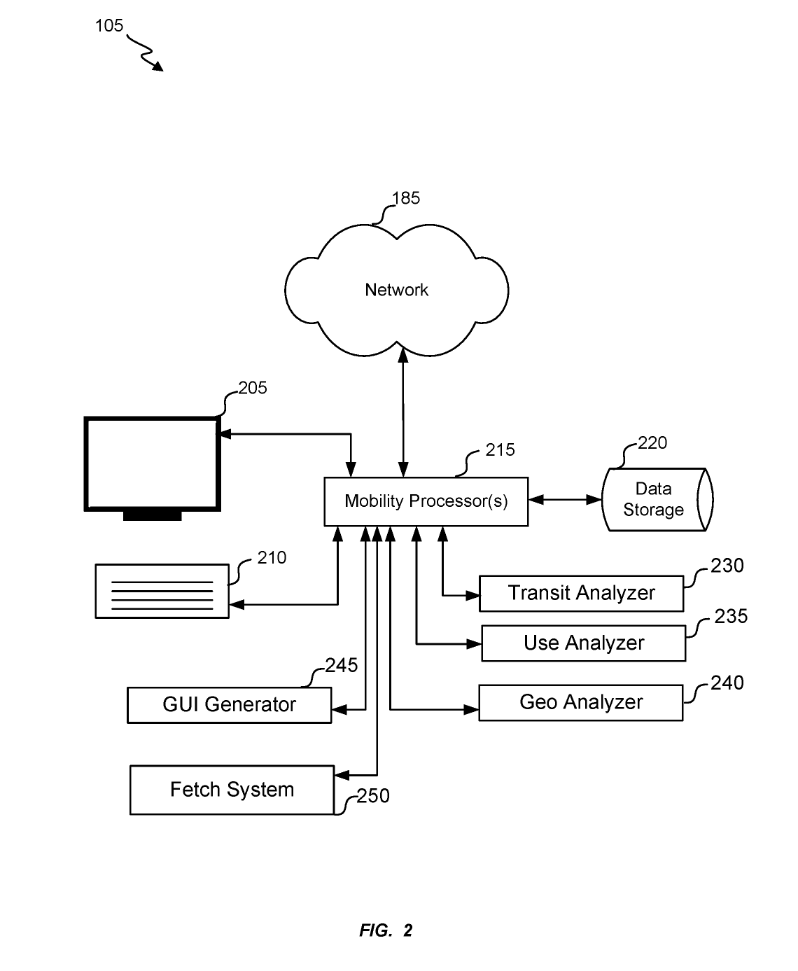

FIG. 2 depicts a block diagram of the mobility system 105. The mobility system has peripherals. Shown here are a display 205 and data entry device 210. It should be understood that the display 205 could be any type including LCD, LED, CRT, OLED, ELD, and PDP. Data entry device 20 can one or more of a keyboard, a mouse, or any other method of entering data including a voice command mechanism. Although only a single display 205 and data entry device 210 are shown here—there could be any number of each in communication with the mobility processor 215. At the heart of mobility system 105 is mobility processor 215. Mobility processor 215 can be any one or more processors of any variety including general purpose single instruction set computers, RISCs, CISCs, and others. Mobility processor 215 communicates with data storage 220. Among other data, data storage 220 stores the accumulated data collected and previously analyzed and computed to create a coordinate map.

Transit analyzer 230 receives transit data resource from the mobility processor 215 and manipulates the transit data resource in response to a pender device 115 or a bender device 110 request for a coordinate map. Use analyzer 235 receives use data from the mobility processor 215 and manipulates the use data in response to a pender device 115 or a bender device 110 request for a coordinate map. Geo Analyzer 240 receives geographical data from the mobility processor 215 and manipulates the geographical data in response to a pender device 115 or a bender device 110 request for a coordinate map. In each of these cases the mobility processor 215 retrieves the required data from data storage 220 and/or it requests that fetch system 250 retrieve the data from transit data resource 170 and/or system-wide data resource 180 over network 185.

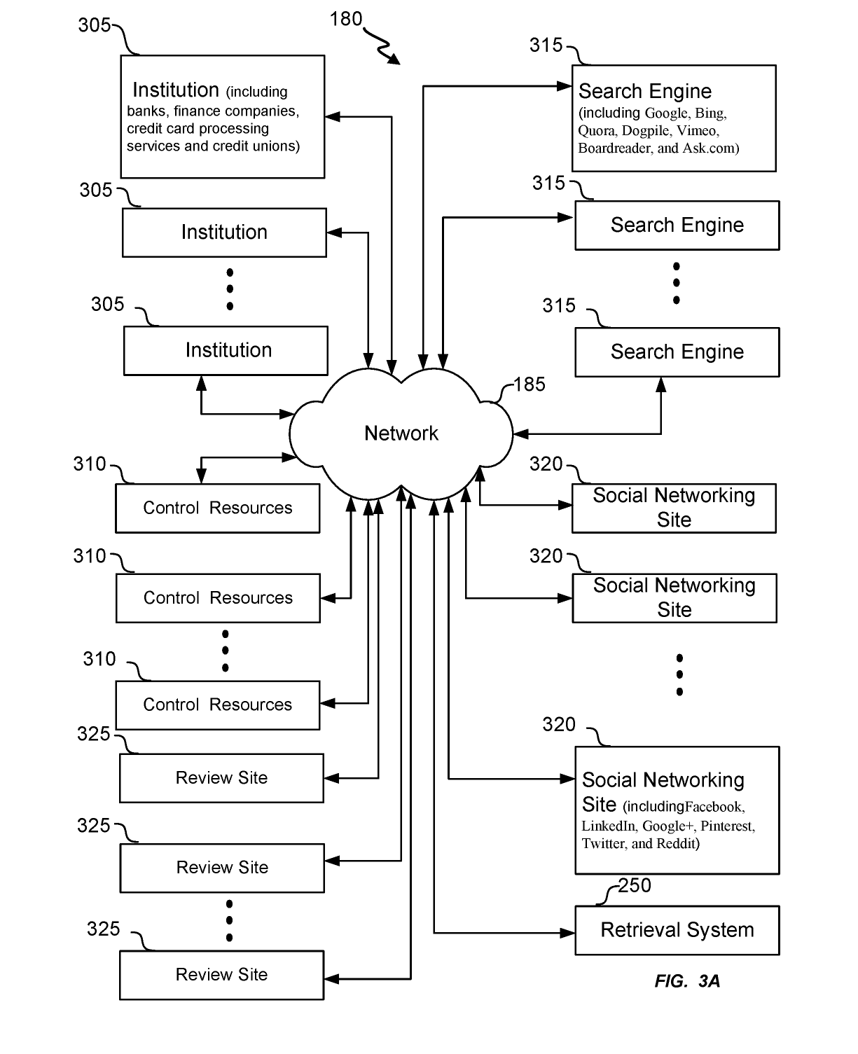

FIG. 3A is a block diagram depicting system-wide data resource 180. System-wide data resource 180 provides the coordinate mapping system 100 with the system-wide data to create the coordinate map. Fetch system 250 queries the system-wide data resource 180 for data to evaluate the factors that determine one or more optimal coordinate points in the coordinate map. Fetch system 250 queries institutions 305 for any number of reasons including to ascertain how busy a business at a particular coordinate point is. Accordingly, fetch system 250 might query one or more institutions 305 for data regarding the volume and amount of credit card transactions conducted at that institution. Control resources 310 includes government agencies and community resources such as the National Weather Service, the Federal Transportation Agency, Better Business Bureau, Chamber of Commerce, taxing agencies, etc. Fetch system 250 queries control resources 310 for various reasons including to determine if a business at a particular coordinate point has any complaints lodged against it. Fetch system 250 could also query the Chamber of Commerce for regional demographic data. Fetch system 250 queries search engines 250 for any number of reasons including to determine all eating establishments at a given coordinate point. Fetch system 250 queries social networking sites 320 for reasons including to determine what types of food is served at eating establishments at a given coordinate point. Review sites 325 include Yelp, Tripadvisor, and Google. Fetch system 250 queries review sites 325 for such reasons as to discover ratings of eating establishments at a given coordinate point. All entities in system-wide data resource 170 are connected to network 185. Network 185 is a system of computers and peripherals that are linked together and can consist of as few as two computing devices connected or millions of computers over a large geographical area with or without wires—such as the interne or the cellular telephone network.

FIG. 3B is a block diagram depicting transit data resource 180. Transit data resource 180 provides coordinate mapping system 100 with transit data to create the coordinate map. Fetch system 250 queries trains system 330 over network 185 for schedule, route, price, and usage data, among other things. Bus systems 335 include school bus systems, campus bus systems, local bus systems, regional bus systems, airport bus systems, special event bus systems, and interstate bus systems. Fetch system 250 queries bus system 335 over network 185 for schedule, routes, price, and usage data among other things. Fetch system 250 queries ride share 350 over network 185 for such data including price, location, and availability. Taxi Company 345 includes regular taxicab companies, and private car services. Fetch system 250 queries taxi company 345 over network 185 for data including rates, hours of operation, time of arrival. Ride share 350 includes ride sharing companies such as airport shuttles, Uber, Lyft, and GetMe. Fetch system 250 queries ride share 350 over network 185 for available cars, time of arrival, and pricing among other things. All entities in transit data resource 170 are connected to network 185. Network 185 is a system of computers and peripherals that are linked together and can consist of as few as two computing devices connected or millions of computers over a large geographical area with or without wires—such as the internet or the cellular telephone network.

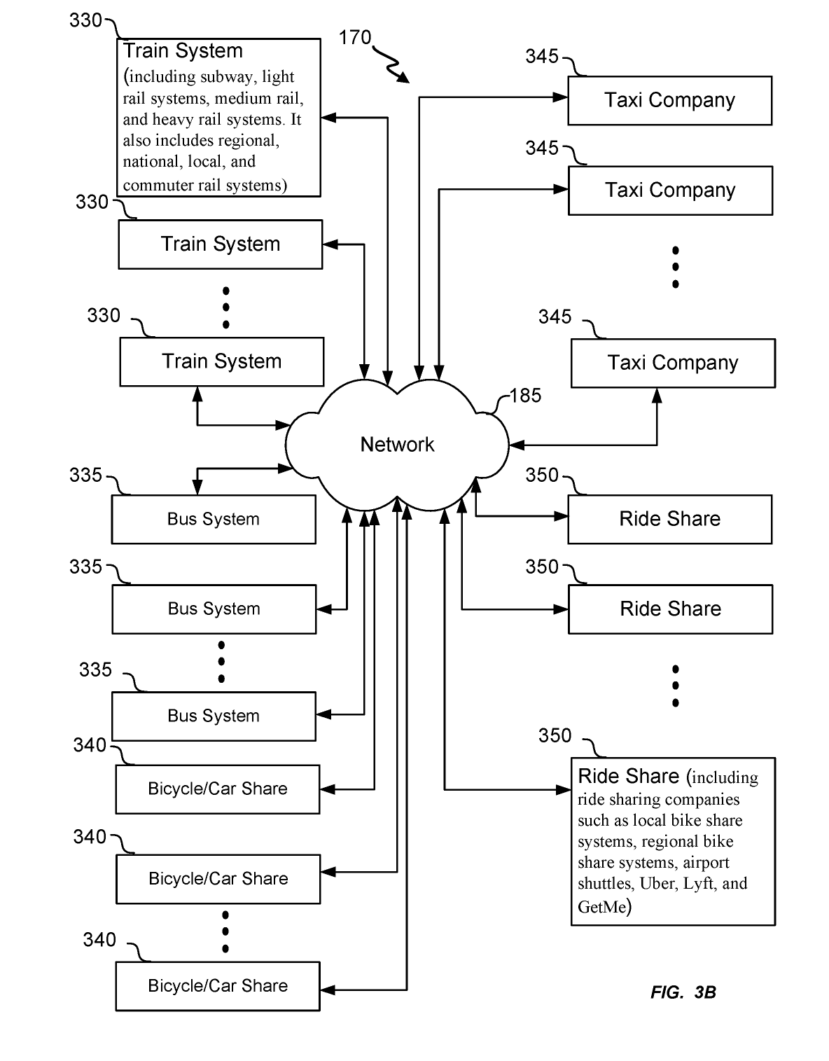

FIG. 4 depicts a coordinate map with possible coordinate points navigationally assessable in a given time period using one navigational system. Navigation systems include a subway line, a train line, and a bus line. The mobility system 105 receives a request over network 185 for a coordinate map that is limited to 20 minutes and one navigational system. In some embodiments transit analyzer 230 generates the coordinate points in the coordinate map after the fetch system 250 queries the transit data resource 170 for schedules and routes using network 185. GUI generator 245 translates the coordinate map into an interface that it delivers over network 185 to a pender device 115 or a bender device 110 connected by network 185 that made the request.

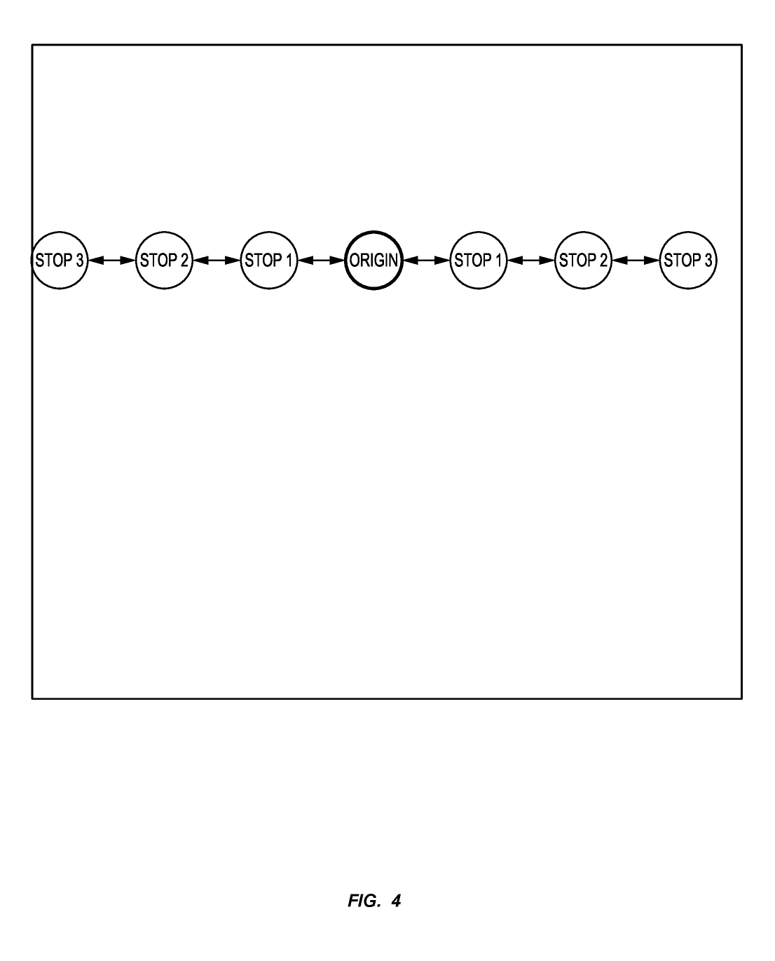

FIG. 5 depicts a coordinate map with possible coordinate points navigationally assessable from an origination point in a given time period with the option of a directional change and changing navigational systems. In some embodiments the mobility system 105 receives a request over network 185 to generate a coordinate map limited to 20 minutes and one change in navigational systems. In that embodiment the transit analyzer 230 generates the coordinate points in the coordinate map after the fetch system 250 queries the transit data resource 170 for schedules and routes for both of the navigational systems using network 185. GUI generator 245 translates the coordinate map into an interface that it delivers over network 185 to a pender device 115 or a bender device 110 connected by network 185 that made the request.

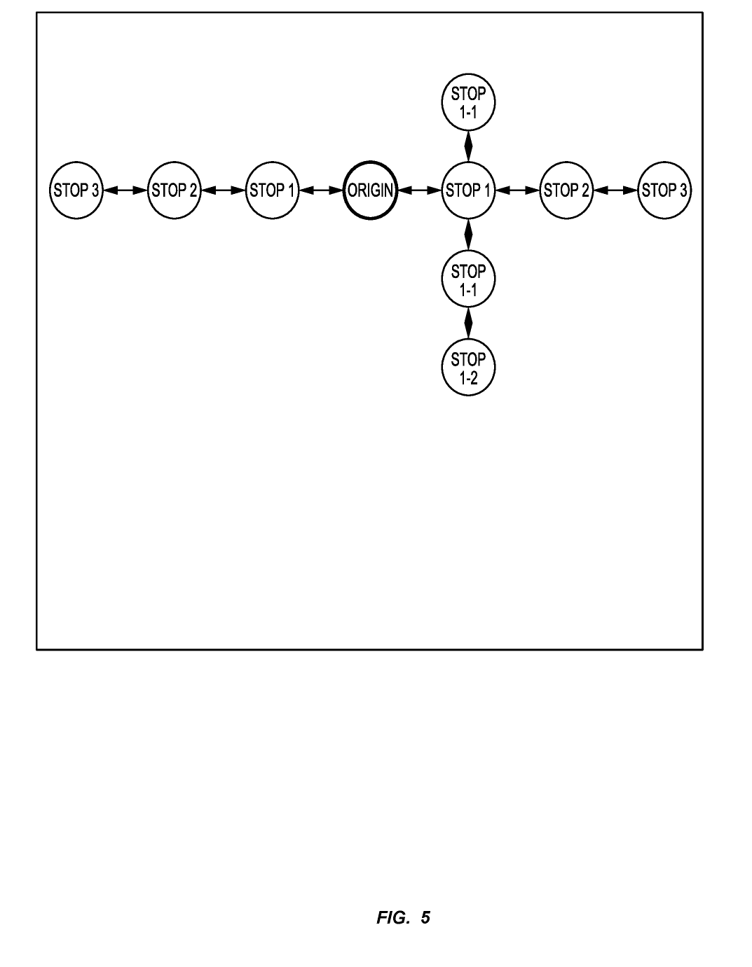

FIG. 6 depicts a coordinate map with possible coordinate points navigationally assessable from an origination point in a given time period with no navigational system changes. A navigational system includes changing trains, buses, etc. The mobility system 105 receives a request over network 185 for a coordinate map that is limited to 20 minutes and one navigational system. In some embodiments transit analyzer 230 generates the coordinate points in the coordinate map after the fetch system 250 queries the transit data resource 170 for schedules and routes using network 185. GUI generator 245 translates the coordinate map into an interface that it delivers over network 185 to a pender device 115 or a bender device 110 connected by network 185 that made the request.

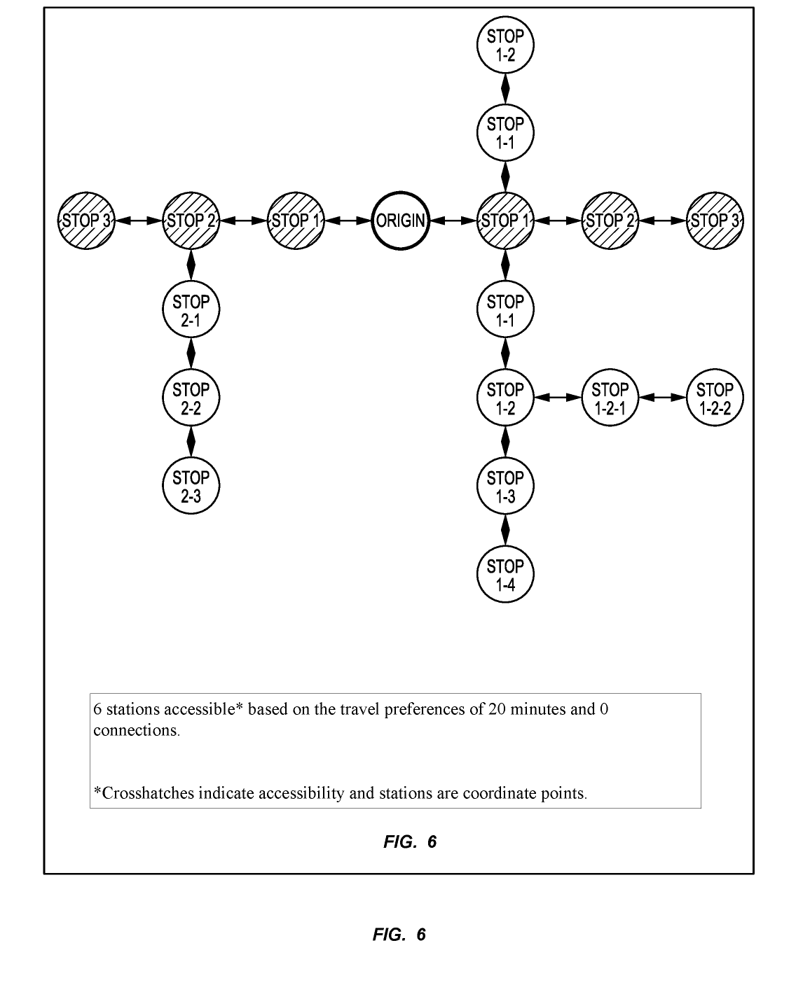

FIG. 7 depicts a coordinate map with possible coordinate points navigationally assessable from an origination point constrained by time and one navigational system change. In some embodiments the mobility system 105 receives a request over network 185 to generate a coordinate map limited to 20 minutes and one change in navigational systems. In that embodiment the transit analyzer 230 generates the coordinate points in the coordinate map after the fetch system 250 queries the transit data resource 170 for schedules and routes for both of the navigational systems associated with one navigational system change using network 185. GUI generator 245 translates the coordinate map into an interface that it delivers over network 185 to a pender device 115 or a bender device 110 connected by network 185 that made the request.

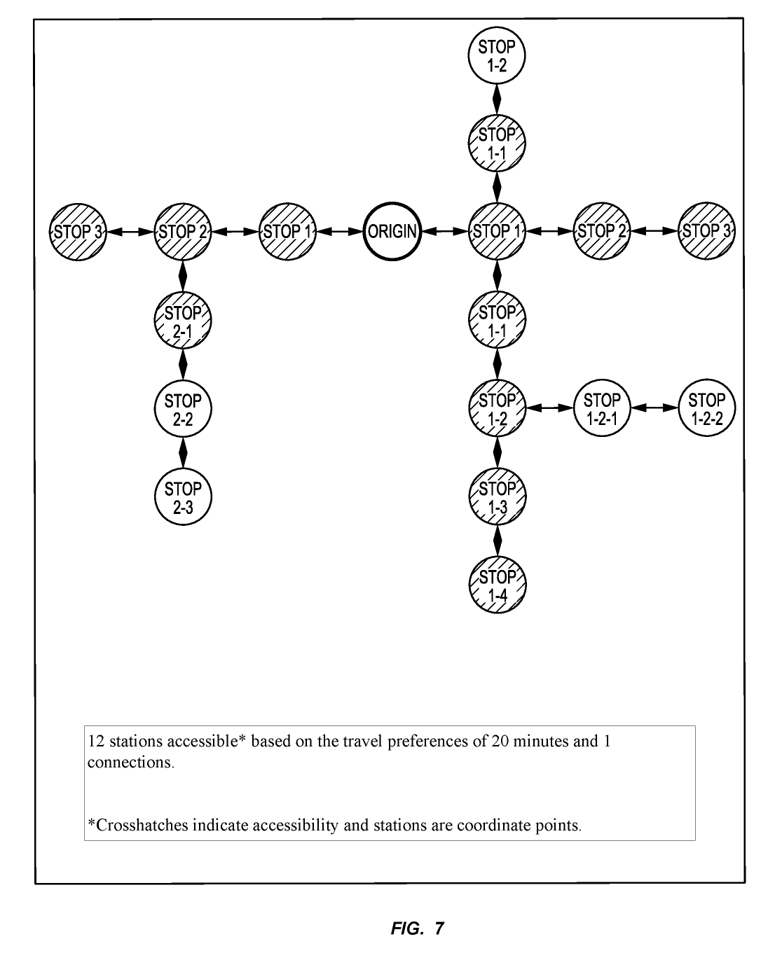

FIG. 8 depicts a coordinate map with possible coordinate points navigationally assessable from an origination point constrained by time and two navigational system changes. In other embodiments the mobility system 105 receives a request over network 185 to generate a coordinate map limited to 20 minutes and two changes in navigational systems. In this embodiment the transit analyzer 230 generates the coordinate points in the coordinate map after the fetch system 250 queries the transit data resource 170 for schedules and routes for all three of the navigational systems associated with two navigational system changes using network 185. GUI generator 245 translates the coordinate map into an interface that it delivers over network 185 to a pender device 115 or a bender device 110 connected by network 185 that made the request.

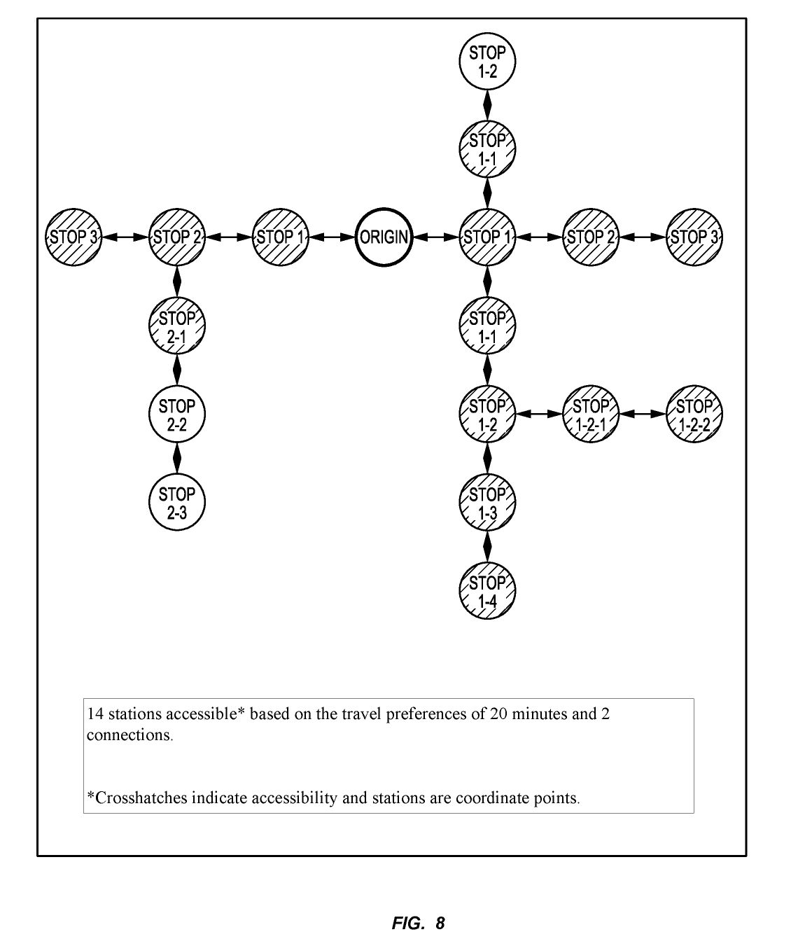

FIG. 9 depicts a coordinate map with possible coordinate points navigationally assessable from an origination point constrained by time, two navigational system changes, and using two navigation types. Navigation types include walking, biking, taking a bus, taking a train, using an automobile, pedicabs, etc. In another embodiment the mobility system 105 receives a request over network 185 to generate a coordinate map limited to 20 minutes, 2 navigation types, and two changes in navigational systems. In this embodiment the transit analyzer 230 generates the coordinate points in the coordinate map after the fetch system 250 queries the transit data resource 170 and the system-wide data resource 180 for schedules and routes for all three of the navigational systems associated with two navigational system changes and for data related to the additional navigation type using network 185. GUI generator 245 translates the coordinate map into an interface that it delivers over network 185 to a pender device 115 or a bender device 110 connected by network 185 that made the request.

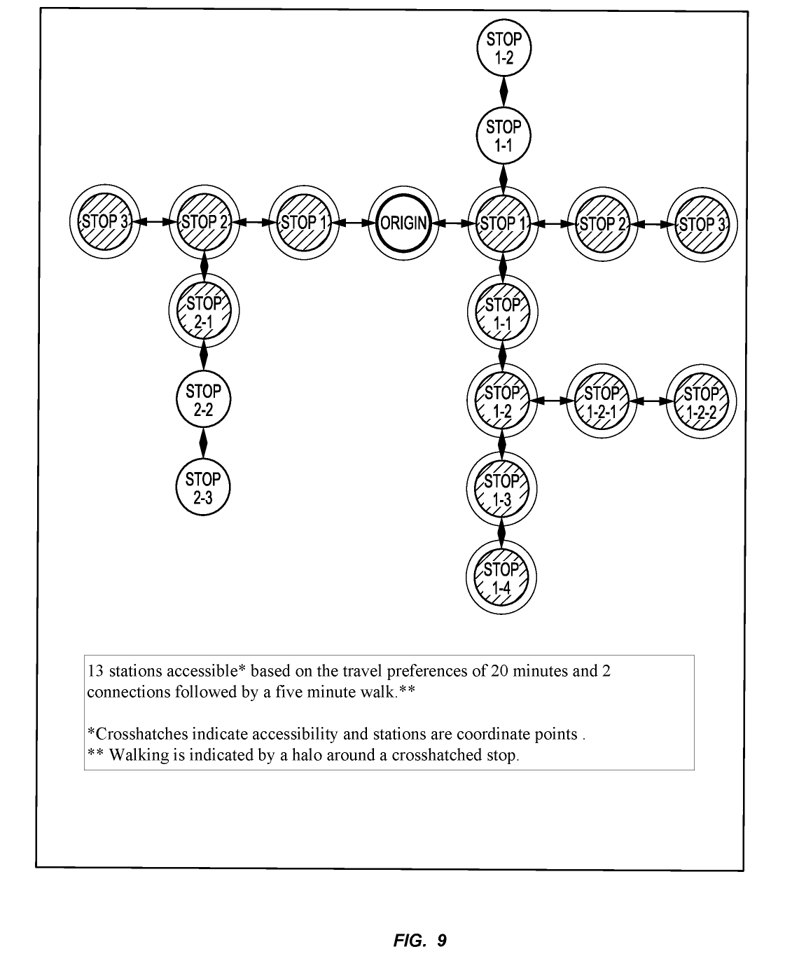

FIG. 10 depicts a coordinate map with possible coordinate points navigationally assessable from an origination point constrained by time, two navigational system changes, and using two navigation types overlaid on a geographic map associated with the navigational systems. In other embodiments the mobility system 105 receives a request over network 185 to generate a coordinate map limited to 20 minutes and two changes in navigational systems. In this embodiment the transit analyzer 230 generates the coordinate points in the coordinate map after the fetch system 250 queries the transit data resource 170 for schedules and routes for all three of the navigational systems associated with two navigational system changes using network 185. Fetch system 250 also queries the system-wide data resource 180 using network 185 for geographical data related to the navigational systems. Geo analyzer 240 generates a map. GUI generator 245 translates the coordinate map and overlays it on the map into an interface that it delivers over network 185 to a pender device 115 or a bender device 110 connected by network 185 that made the request.

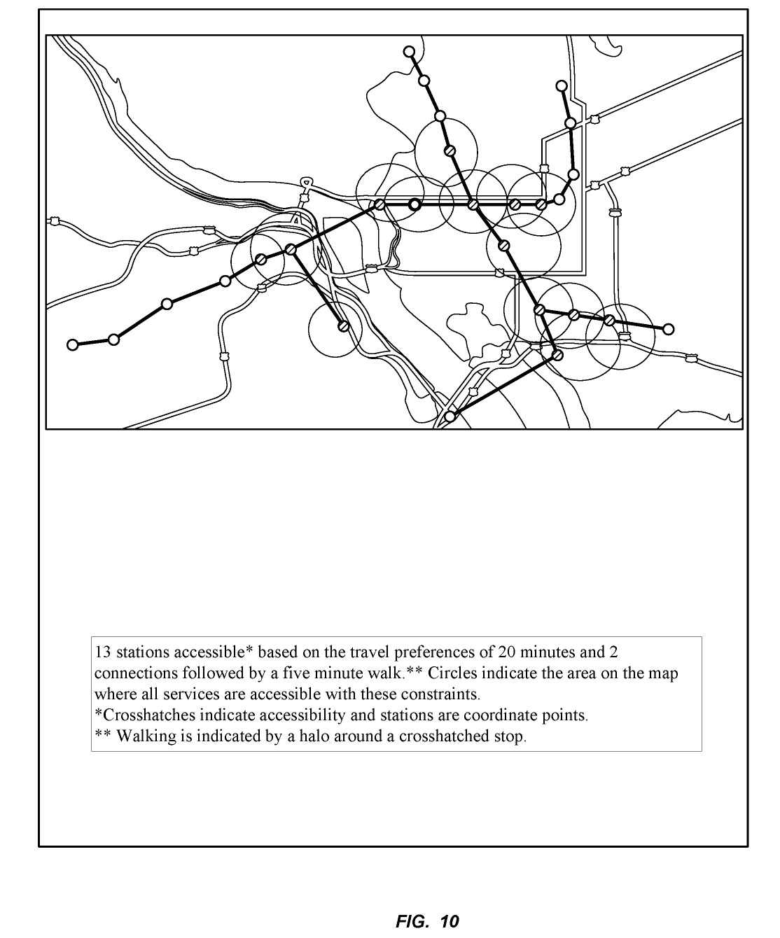

FIG. 11 depicts a coordinate map with possible coordinate points navigationally assessable from an origination point constrained by time, two navigational system changes, and using three navigation types overlaid on a geographic map associated with the navigational systems during a weekday. In yet another embodiment the mobility system 105 receives a request over network 185 to generate a coordinate map limited to 20 minutes, two changes in navigational systems, and three navigation types. In this embodiment the transit analyzer 230 generates the coordinate points in the coordinate map after the fetch system 250 queries the transit data resource 170 for schedules and routes for all three of the navigational systems associated with two navigational system changes using network 185. Fetch system 250 also queries the system-wide data resource 180 using network 185 for geographical data related to the navigational systems and the navigation types. User Analyzer 235 analyzes the data related to the navigation types to generate bounded areas around the coordinate points in the coordinate map. Geo analyzer 240 generates a map. GUI generator 245 translates the coordinate map and overlays it on the map into an interface that it delivers over network 185 to a pender device 115 or a bender device 110 connected by network 185 that made the request.

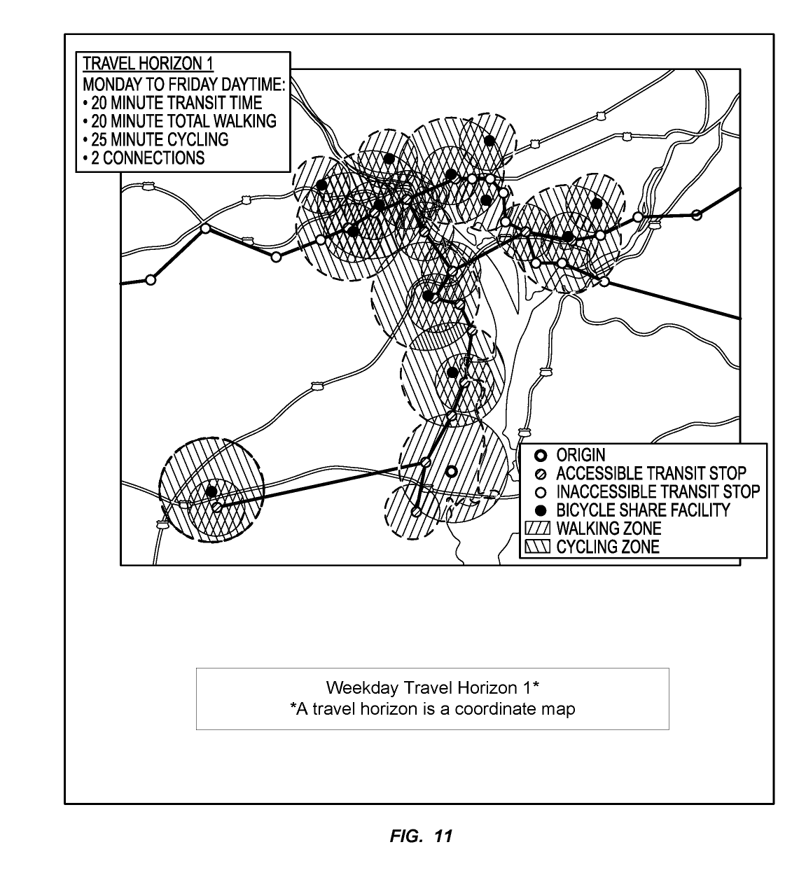

FIG. 12 depicts a coordinate map with possible coordinate points navigationally assessable from an origination point constrained by time, two navigational system changes, and using three navigation types overlaid on a geographic map associated with the navigational systems during a weekend day. In a similar embodiment the mobility system 105 receives a request over network 185 to generate a coordinate map limited to 20 minutes, two changes in navigational systems, and three navigation types. In this embodiment the transit analyzer 230 generates the coordinate points in the coordinate map after the fetch system 250 queries the transit data resource 170 for schedules and routes for all three of the navigational systems associated with two navigational system changes using network 185. Fetch system 250 also queries the system-wide data resource 180 using network 185 for geographical data related to the navigational systems and the navigation types. User Analyzer 235 analyzes the data related to the navigation types to generate bounded areas around the coordinate points in the coordinate map. Geo analyzer 240 generates a map. GUI generator 245 translates the coordinate map and overlays it on the map into an interface that it delivers over network 185 to a pender device 115 or a bender device 110 connected by network 185 that made the request.

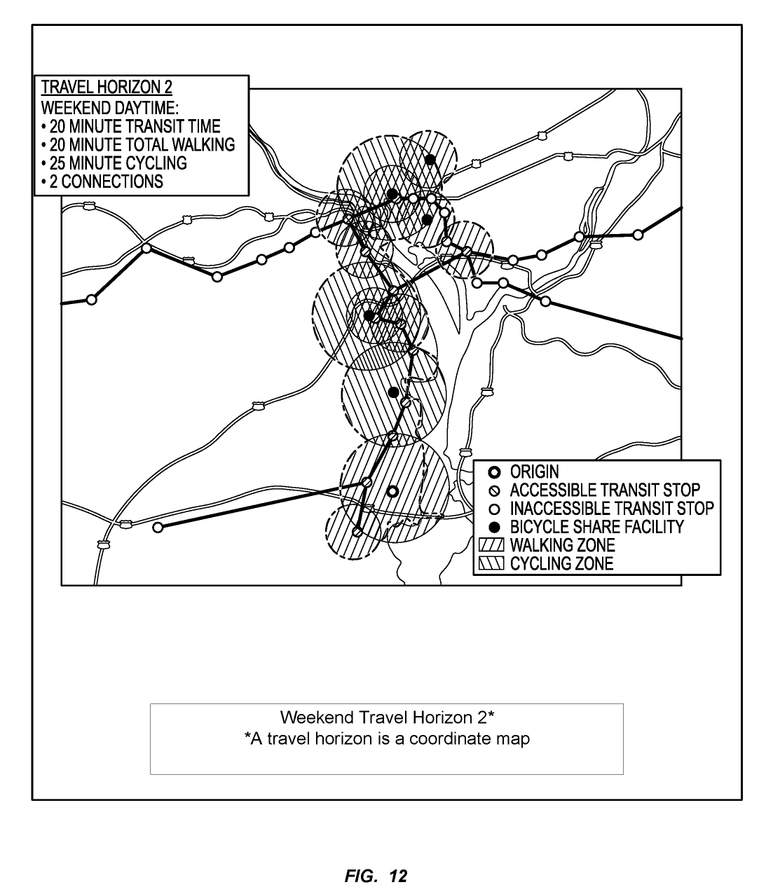

FIG. 13 depicts a coordinate map with possible coordinate points navigationally assessable from an origination point constrained by time, two navigational system changes, and using two navigation types overlaid on a geographic map associated with the navigational systems during an evening when one of the navigation types has been eliminated. In yet another similar embodiment the mobility system 105 receives a request over network 185 to generate a coordinate map limited to 20 minutes, two changes in navigational systems, and two navigation types. In this embodiment the transit analyzer 230 generates the coordinate points in the coordinate map after the fetch system 250 queries the transit data resource 170 for schedules and routes for all three of the navigational systems associated with two navigational system changes using network 185. Fetch system 250 also queries the system-wide data resource 180 using network 185 for geographical data related to the navigational systems and the navigation types. User Analyzer 235 analyzes the data related to the navigation types to generate bounded areas around the coordinate points in the coordinate map. Geo analyzer 240 generates a map. GUI generator 245 translates the coordinate map and overlays it on the map into an interface that it delivers over network 185 to a pender device 115 or a bender device 110 connected by network 185 that made the request.

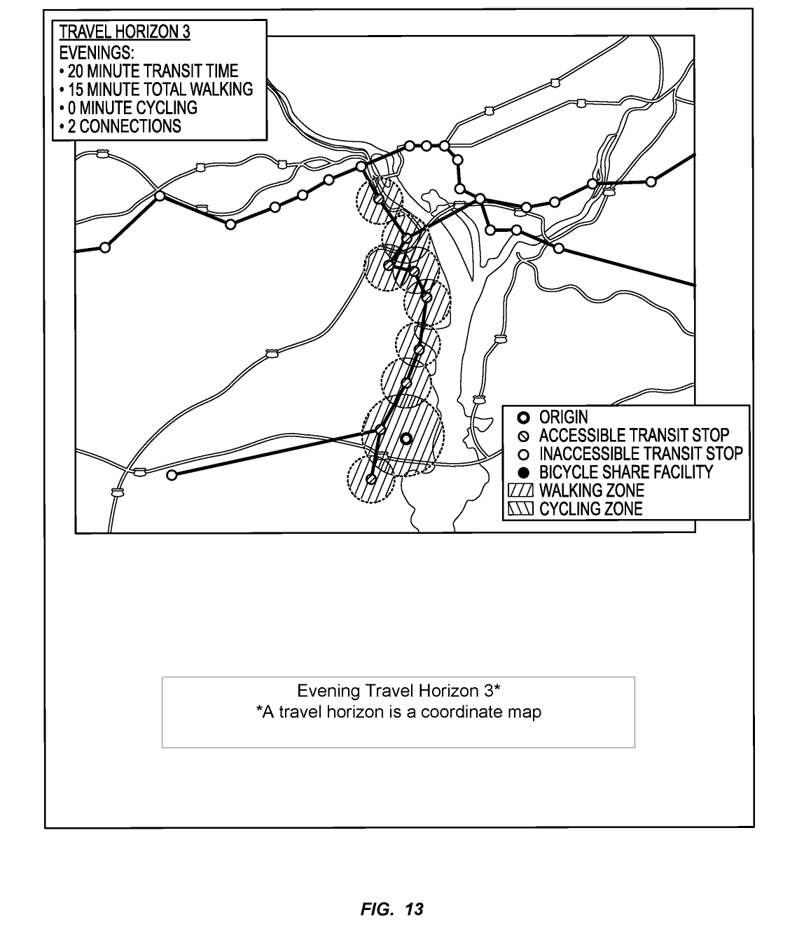

FIG. 14 shows coordinate maps from FIGS. 11, 12 and 13 overlaid on one another to depict the dynamic nature of a coordinate map. GUI generator 245 delivers the result over network 185 to a pender device 115 or a bender device 110 connected by network 185 that made the request. FIG. 14 depicts the dynamic nature of the coordinate map and shows how it changes over time as there are coordinate points that are not common to all three coordinate maps depicted in FIGS. 11, 12, and 13.

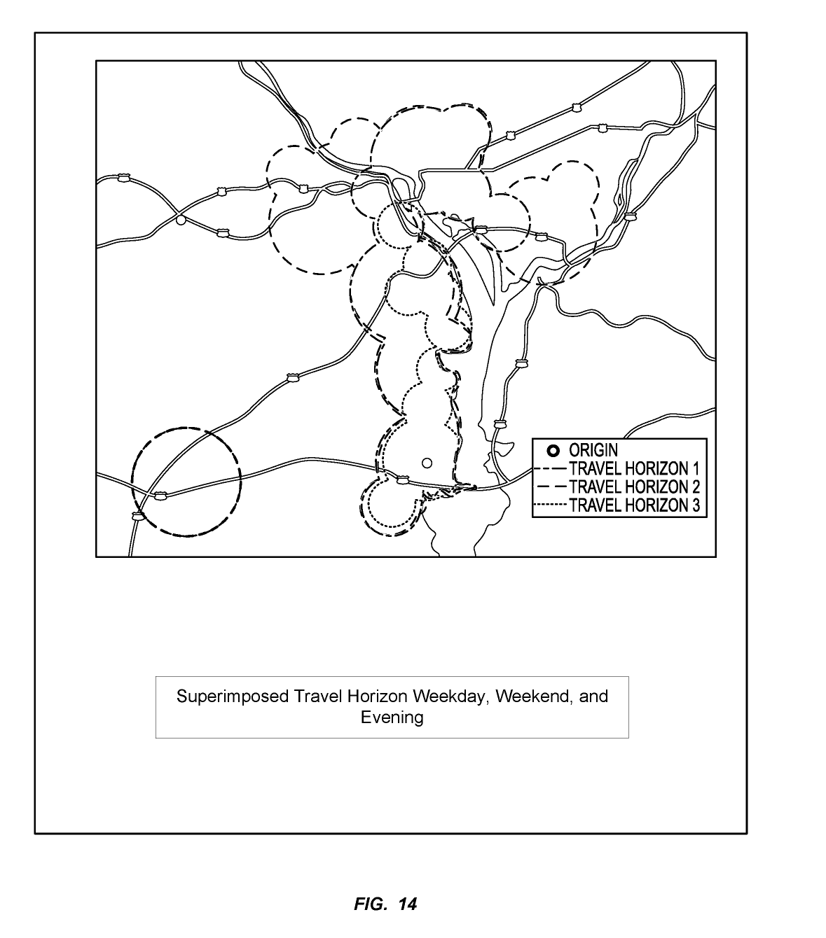

FIG. 15 depicts a table showing bearing and distance between coordinate points in an area. Mobility system 105 computes both distance and bearing utilizing data retrieved by fetch system 250 from system-wide data resource 180 and/or transit data resource 170 over network 185. A pender 115 or bender 110 might request this data to determine the level of activity at a coordinate point.

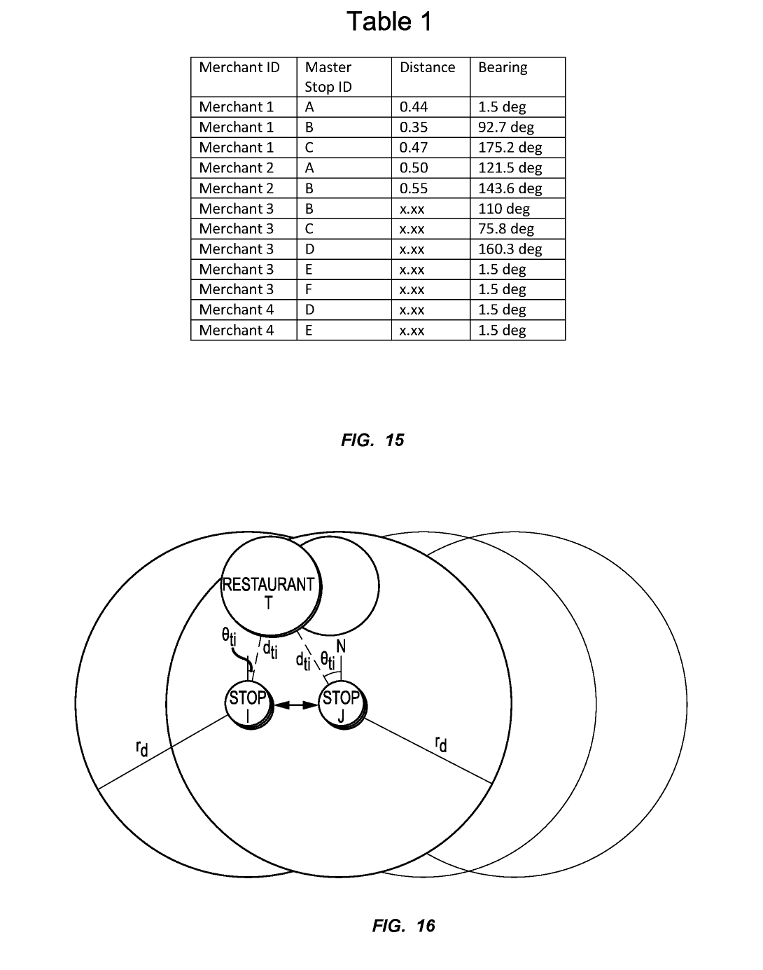

FIG. 16 depicts the geometrical algorithm for computing the bearing and distance from FIG. 15 that mobility system 105 employs to build the table of FIG. 15.

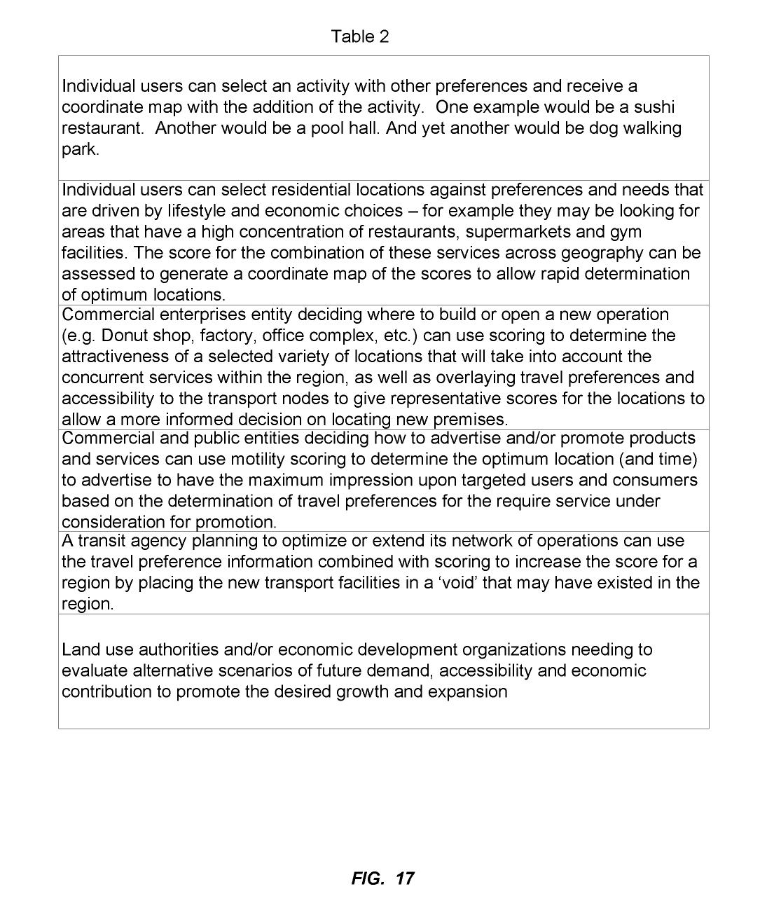

FIG. 17 Table 2 that enumerates examples of some of the various use cases for coordinate mapping. In this case user constraints are expounded upon from navigation time, navigational changes, navigational, types to include an activity or a geographic area.

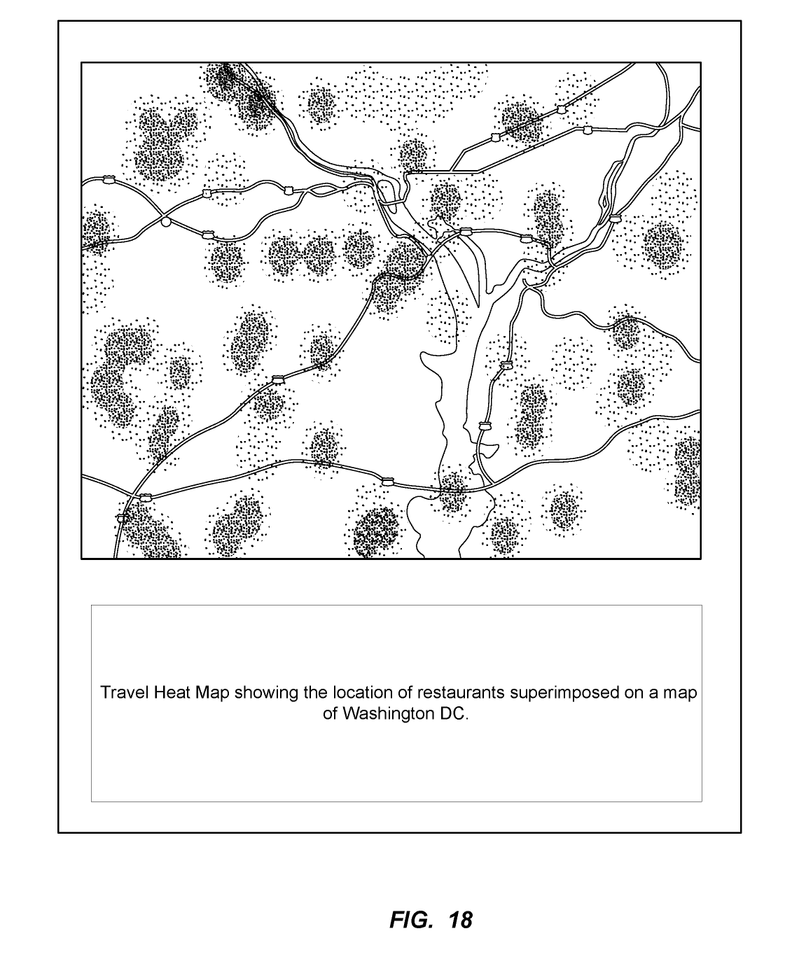

FIG. 18 depicts a geo-coordinate heat map for one of the use cases enumerated in FIG. 17.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments. It is also the case that modules, software, or algorithms can be performed on one server, multiple servers or share the same server. A platform is a major piece of software, such as an operating system, an operating environment, or a relational database or data store, under with various smaller application programs can be designed to run. An operating system is the most important software program running on most computer systems. It manages a processors memory, processes, all of the software and programs loaded onto it, and all of the connected hardware. The operating system's job is to manage all of the software and hardware on the computer. Most of the time, there are many different software programs operating at once as well as multiple connected hardware devices. There are many operating systems—the most basic is the disk operating system or “DOS.” Each type of computer or device typically has its own different operating systems. Some typical operating systems are iOS, Windows, Android, and Linux.

The networks disclosed may be implemented in any number of topologies. A network is made of many computing devices that can include computers, servers, mainframe computers, network devices, peripherals, or other devise connected together. A network allows these devices to share data and communicate with each other. The most prominent network is the Internet—that connects billions of devices all over the world. There are many types of network devices including: computers, consoles, firewalls, hubs, routers, smartphones, switches, wearables, watches, and cameras. Networks are set up in many different ways referred to as network topologies. Some of the most common topologies include tree, hybrid, ring, mesh star, and bus. The tree topology is the generally used topology. A computer is typically an electronic device for storing and processing data according to instruction it reads. A console is a text entry and display device. A firewall is network security system, either hardware- or software-based, that controls incoming and outgoing network traffic based on a set of rules, and acts as a barrier between a trusted network and other untrusted networks—such as the Internet—or less-trusted networks—a firewall controls access to the resources of a network through a positive control model. This means that the only traffic allowed onto the network defined in the firewall policy is; all other traffic is denied. A hub is a connection point for multiple devices in a network. A hub typically has multiple ports such that if packets of data arrive at one port they are copied to the other ports. A router is a device that forwards data packets along the network. A router connects two or more networks such as an intranet to the internet. Routers use headers and forwarding tables to determine how data packets should be sent using certain paths in the network. The typical router protocol using ICMP to communicate and configure the best path. A network switch is different from a router. Switches serve as controllers that enable networked devices to communicate with each other. Switches create networks while routers connect networks together.

Networks operate on the seven layer open system interconnection (OSI) model. The OSI model defines a conceptual networking framework to implement protocols and divides the task of networking into a vertical stack of the seven layers. In the OSI model, communication control is passed through the layers from the first to the seventh layer. The first or “top” layer is the “physical” layer. Layer 1 transmits the bit stream of ones and zeros indicated by electrical impulse, light, or radio frequency signals—thus providing a method of interacting with actual hardware in a meaningful way. Examples of the physical layer include Ethernet, FDDI, B8ZS, V.35, V.24, and RJ45. The second layer is called the Data Link layer. At layer 2 data packets are encoded and decoded into a bit stream in compliance with transmission protocols that control flow control and frame synchronization. The Data Link layer 2 is actually a combination of two different layers: the Media Access Control (MAC) layer and the Logical Link Control (LLC) layer. The MAC layer controls a computer's access to the network. The LLC basically controls frame synchronization, flow control, and various types of error correction. Examples of the Data Link layer include PPP, FDDI, ATM, IEEE 802.5/802.2, IEEE 802.3/802.2, HDLC, and Frame Relay. The third OSI layer, called the “Network” layer, provides the switching and routing technology to create logical paths to transmit data from one node to another in the network. Layer. The Network layer also performs the function of routing, forwarding, addressing, internetworking, error handling, congestion control, and packet sequencing. Layer 3 examples include AppleTalk, DDP, IP, and IPX. The fourth OSI layer is the Transport layer. Layer 4 provides transparent transfer of data between devices. Layer 4 also performs error recovery and provides flow control for complete data transfer. Examples of layer 4 include SPX, TCP, and UDP. OSI layer 5 called the Session layer because it manages and terminates the connections between different applications. The Session layer coordinates communication between applications. It sets up communications and terminates the communications between applications at each end—establishing and ending a “session.” Examples include NFS, NetBios, names, RPC, and SQL. Layer 6 is called the Presentation Layer. Layer 6 is really the “transformation” layer—transforming data from the final layer to a format the network understands and vice versa. Layer 6 formats and encrypts data sent on the network and decrypts the data from the network. Examples include ASCII, EBCDIC, TIFF, GIF, PICT, JPEG, MPEG, and MIDI. Finally, the last layer 7, is called the Application Layer. Everything at this layer is specific to applications, and this layer provides the services for email, file transfers, and other network applications. Examples include WWW browsers, NFS, SNMP, FTP, Telnet, and HTTP.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), complex instruction set computers (CISCs), reduced instruction set computers (RISCs), advanced RISC machines (ARMs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. A processor is implemented in logic circuitry that includes the basic functions of AND, NAND, OR, and NOR functions. The circuitry responds to the basic instructions that operate an computing device. In some computing devices the processor is actually referred to a as microprocessor. Functionally, processors are typically composed of RAM as well as address and data buses, the processing circuitry and accumulators. The busses supply the data and programming instructions from RAM, ROM, CACHE, or other memory to the processing circuitry. The speed of a processor depends both on the speed of the processing circuitry as well as the speed of the data and address busses that supply the circuitry. And the speed of the data and address buses are also gated by the speed of the RAM. It is critical that all of these components have speeds that are matched to one another to maximize processor performance. Processors use machine level instruction codes to manipulate data. Other instructions must be compiled to machine level instructions to for the processor to perform the operations. Dual core processors have dual processing circuitry and multiple address and data buses.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing data. The term “machine-readable medium” includes, but is not limited to portable or fixed storage devices, optical storage devices, and/or various other storage mediums capable of storing that contain or carry instruction(s) and/or data. Cache memory, also called the central processing unit (CPU) memory, is random access memory that the processor can access more quickly than standard RAM. Cache memory is typically integrated into the circuitry with the processing unit, but sometimes can be placed on a separate chip. The principle purpose of cache memory is to store the program instruction for the operational software such as an operating systems. Most long running software instructions reside in cache memory if they are accessed often.

While the principles of the disclosure have been described above in connection with specific apparatuses and methods, it is to be clearly understood that this description is made only by way of example and not as limitation on the scope of the disclosure.

What is claimed is:

1. A method for generating a coordinate map by synchronizing navigability with merit of activity at coordinate points comprising:
receiving a query, from a user device for the coordinate map, over a network, the query including a first coordinate point, wherein the first coordinate point is at an origination point, and one or more constraints, the one or more constraints comprising:
an activity,
a first time,
one or more changes; and
one or more types;
fetching first data, from one or more servers, over the network, wherein the first data includes usage, schedules, and/or routes;
fetching second data from the one or more servers, over the network, wherein the second data includes data for the activity and/or data for the one or more types;
manipulating the first data using a transit analyzer to produce a first result;
manipulating the first data and the second data using a use analyzer to produce a second result;
manipulating the first data and the second data using a geo analyzer to produce a third result;
transforming the first result, the second result, and the third result into the coordinate map comprising at least a second coordinate point, wherein the second coordinate point complies with the one or more constraints;
embedding the coordinate map into a notification;
sending, over the network, the notification to the user device.

2. The method for generating a coordinate map by synchronizing navigability with merit of activity at coordinate points of claim 1, the one or more constraints further comprising a geographic area.

3. The method for generating a coordinate map by synchronizing navigability with merit of activity at coordinate points of claim 1, the one or more constraints further comprising a second time for a first type.

4. The method for generating a coordinate map by synchronizing navigability with merit of activity at coordinate points of claim 1, wherein the activity is dining at a restaurant.

5. The method for generating a coordinate map by synchronizing navigability with merit of activity at coordinate points of claim 1, wherein the activity is shopping at retail establishment.

6. The method for generating a coordinate map by synchronizing navigability with merit of activity at coordinate points of claim 1, wherein the activity is recreational.

7. The method for generating a coordinate map by synchronizing navigability with merit of activity at coordinate points of claim 1, wherein the activity is going to work.

8. A system for generating a coordinate map by synchronizing navigability with merit of activity at coordinate points comprising:
a network;
a mobility processor configured to:
receive a query from a user device, over the network, for the coordinate map, including a first coordinate point, wherein the first coordinate point is at an origination point, and one or more constraints, the one or more constraints comprising:
an activity,
a first time,
one or more changes, and
one or more types;
embed the coordination map in a notification; and
send the notification to the user device, over the network;
one or more servers;
a fetch system configured to retrieve, over the network:
first data from the one or more servers, wherein the first data includes usage, schedules, and/or routes; and
second data from the one or more servers, wherein the second data includes data for the activity and/or data for the one or more types;
a transit analyzer configured to manipulate the first data to produce a first result;
a use analyzer configured to manipulate the first data and the second data to produce a second result;
a geo analyzer configured to manipulate the first data and the second data to produce a third result; and
a GUI generator configured to transform the first result and second result and the third result into the coordinate map comprising at least a second coordinate point, wherein the second coordinate point complies with the one or more constraints.

9. The system for generating a coordinate map by synchronizing navigability with merit of activity at coordinate points of claim 8, the one or more constraints further comprising a second time for one type.

10. The system for generating a coordinate map by synchronizing navigability with merit of activity at coordinate points of claim 8, the one or more constraints further comprising a geographic area.

11. The system for generating a coordinate map by synchronizing navigability with merit of activity at coordinate points of claim 8, wherein the activity is dining at a restaurant.

12. The system for generating a coordinate map by synchronizing navigability with merit of activity at coordinate points of claim 8, wherein the activity is shopping at retail establishment.

13. The system for generating a coordinate map by synchronizing navigability with merit of activity at coordinate points of claim 8, wherein the activity is recreational.

14. The system for generating a coordinate map by synchronizing navigability with merit of activity at coordinate points of claim 8, wherein the activity going to work.

15. A non-transitory computer readable medium, for generating a coordinate map by synchronizing navigability with merit of activity at coordinate points, having instruction sets stored thereon that, when executed by computer, cause the computer to:
receive a query from a user device, over a network, for the coordinate map, including a first coordinate point, wherein the first coordinate point is at an origination point, and one or more constraints, the one or more constraints comprising:
an activity,
a first time,
one or more changes, and
one or more types;
fetch first data, over the network, from one or more servers, wherein the first data includes usage, schedules, and/or routes; and
fetch second data, over the network, from the one or more servers, wherein the second data includes data for the activity and/or data for the one or more types;
manipulate the first data to produce a first result;
manipulate the first data and the second data to produce a second result;
manipulate the first data and the second data to produce a third result;
transform the first result and second result and the third result into the coordinate map comprising at least a second coordinate point, wherein the second coordinate point complies with the one or more constraints;
embed the coordination map in a notification; and
send the notification to the user device, over the network.

16. The non-transitory computer readable medium, for generating a coordinate map by synchronizing navigability with merit of activity at coordinate points, having instruction sets stored thereon of claim 15, the one or more constraints further comprising a time of day constraint.

17. The non-transitory computer readable medium, for generating a coordinate map by synchronizing navigability with merit of activity at coordinate points, having instruction sets stored thereon of claim 15, the one or more constraints further comprising geographic area.

18. The non-transitory computer readable medium, for generating a coordinate map by synchronizing navigability with merit of activity at coordinate points, having instruction sets stored thereon of claim 15, wherein the activity is dining at a restaurant.

19. The non-transitory computer readable medium, for generating a coordinate map by synchronizing navigability with merit of activity at coordinate points, having instruction sets stored thereon of claim 15, wherein the activity is shopping at retail establishment.

20. The non-transitory computer readable medium, for generating a coordinate map by synchronizing navigability with merit of activity at coordinate points, having instruction sets stored thereon of claim 15, wherein the activity is a recreational activity.
